(19) United States
(12) Patent Application Publication
(10) Pub. No.: US 2005/0065814 A1
(43) Pub. Date: Mar. 24, 2005

(54) Device for the parameter configuration of multimodal measuring appliances

(76) Inventors: Markus Schmidt, Nurnberg (DE); Volker Schmidt, Erlangen (DE); Sven Tiffe, Wien (AT)

Correspondence Address: HARNESS, DICKEY & PIERCE, P.L.C., P.O.BOX 8910, RESTON, VA, 20195, US

(21) Appl. No.: 10/492,777

(22) PCT Filed: Sep. 27, 2002
(86) PCT No.: PCT/DE02/03674

(30) Foreign Application Priority Data
Oct. 16, 2001 (DE) 101 51 029.2

(51) Int. Cl. G06F 17/60

(52) U.S. Cl. 705/2; 600/300; 128/920; 705/8

(57) ABSTRACT

A device is for enhancing the use of different measuring and examination appliances during medical examinations. The device includes an expert system for drawing up a patient-specific plan for the selection of the appliances and for parameter configuration on the basis of a tentative diagnosis or a defined medical question.

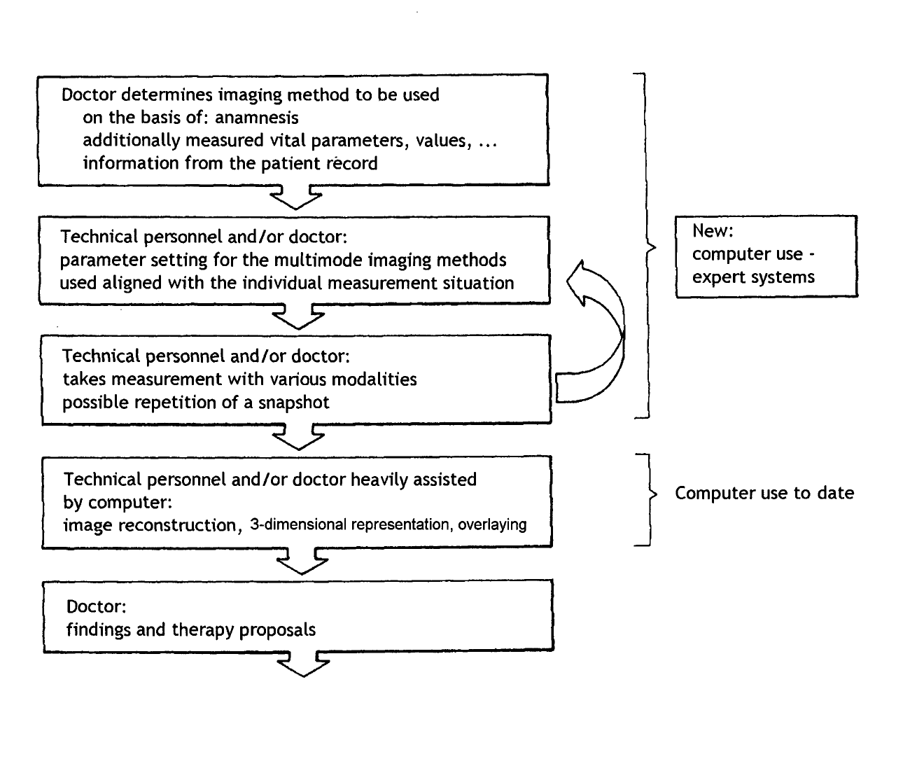

The invention relates to an apparatus for optimizing the use of different measuring and examination appliances for medical examinations.

Medical appliances used predominantly on an individual basis in examinations to date, such as computer tomographs, magnetic resonance appliances, ultrasound appliances, etc., are increasingly being used in combination. Setting the individual parameters for an examination, such as field strength and foo bar in a magnetic resonance appliance or foo and bar in a computer tomograph, is getting more and more complex for multimode examinations and measurements, in the same degree as appliances are combined.

Ever more complicated modes of user operation and a larger choice of systems require even more work involvement in order to set all of the parameters and to find the correct modalities. The more complex technology means that very many more physical parameters need to be set in the multimodality appliances. At the same time, the medical problems solved using these appliances are likewise becoming more complex, since, by way of example, the locating of a tumor, the fusion of diagnostics and therapy or the introduction of contrast agents for different modalities (CT, MR, US, etc.) are much more complicated processes.

The result, both from a medical point of view and from a technical point of view, is thus very much more complex processes which need to be very tightly inter-meshed with one another. This tight intermeshing presupposes a very large amount of medical and at the same time technical understanding on the part of the operating personnel.

The invention is therefore based on the object of providing an apparatus for optimizing the use of different measuring and examination appliances for medical examinations which significantly reduces the burden on the operating personnel to date, who have had to perform all of these implementation processes.

The invention achieves this object by virtue of such an apparatus being characterized by an expert system for creating a patient-specific plan for the purposes of selection of the appliances and parameter configuration on the basis of a suspicious diagnosis or a medical defined problem, where the expert system preferably simultaneously controls and supervises the implementation of the examination plan, including the administration of medicaments, contrast agents or the like before, during and after the examination.

The inventive expert system, which is preferably connected to available information systems, such as patient records, appliance databases, medical lexicons or the like and which is also intended, in particular, to take into account modality-specific and examination-specific contraindications for plan production, takes an initial suspicion, that is to say an initial diagnosis, as a basis for automatically creating a treatment plan which stipulates the selection and order of the medical examinations to be carried out using the available appliances and at the same time ascertains and sets parameters for the various measuring appliances on a patient-specific basis.

The inventive expert system is thus, so to speak, a type of “translator” between the medical problem or task and the appendant requisite setting and control tasks for the technology of the examination appliances.

In one development of the invention, provision may be made in this context for the inventive apparatus to comprise a patient monitoring facility, particularly an intensive medicine monitoring facility, for example, in order to be able to make plan alignments during the examination in line with the state values obtained and any critical states discovered in the process, and possibly also to prompt termination of the examination.

In this context, the expert system should preferably be designed such that it can enter into a direct dialog with the medical personnel in order to generate enquiries to the medical personnel directly if required, in the event of missing or conflicting data which cannot be obtained from suitable sensors, the patient record, the hospital information system or other information systems.

Beside the opportunity which naturally exists for using such an expert system in the hospital in order to coordinate the examination appliances available there, it has been found to be expedient in one refinement of the invention for the expert system to be arranged on the premises of a service provider centrally for various users, since this affords a series of advantages. First, alignment of the expert system's decision principles with most recent knowledge from studies and continual fine tuning is much easier and more efficient to achieve with such a central system than with decentralized systems at every place of examination, that is to say in every large laboratory, hospital or the like. Each examination, measurement or treatment makes its own contribution to an extended capacity for the expert system, and a constant service can be provided in addition to an appliance with associated support and training.

In this context, it is also still within the scope of the invention to provide, precisely in the case of an expert system having a decentralized distributed arrangement on the Internet, a service provider with peer to peer concepts for the expert system in order to improve availability and to distribute the requisite computational load.

Other advantages, features and particulars of the invention can be found in the description below of an exemplary embodiment and also with reference to the drawing, which schematically shows a flowchart for an inventive examination method using medical appliances, the inventive modification of such a method being indicated to the right thereof.

The stages in determining the imaging methods to be used or else other examination appliances, the parameter setting for the selected appliances, the taking of the measurements and, if appropriate, assessment of the measurement results in order to stipulate whether any repetition or additional examination is necessary, that is to say the top three stages in the conventional method, are replaced, in line with the invention, by the use of a computer, that is to say by an expert system which—as has already been explained in detail further above, of course—itself selects the appliances which are to be used for examination on the basis of a suspicious diagnosis, configures them on a patient-specific basis and also monitors the performance of the examinations.

On the basis of the medical task, this expert system generates a patient-specific plan which undertakes appliance control. For generating the plan, data from available information systems are used (e.g. from the HIS). Missing knowledge is requested from the personnel. The plan itself is then executed in the course of the examination. In this case, it may be necessary to carry out an interactive procedure controlled by the examiner, it being equally possible for the plan to proceed without further interaction with the examiner (for example both a CT and an MR image need to be taken). Another variant is plan modification during the examination step, for example if the ideal recording times cannot be defined until during the examination on the basis of the inflow times and on the basis of contrast agent concentrations attained.

The expert system for setting multimode measuring appliances can set all of the relevant measurement parameters automatically on the basis of the patient data, on the basis of the task and on the basis of additional details provided by the operator.

The expert system is able to take into account a patient's health data, for example age or weight, in the parameter setting without any interaction by the operator.

In particular, the expert system also takes into account modality-specific and examination-specific contraindications (e.g. contrast agent allergies, pregnancy, heart attack, renal insufficiency, hepatic insufficiency, etc.) for plan creation.

If the data are incomplete, the expert system attempts to ascertain the required data independently. If the data cannot be detected by suitable sensors, from the hospital information system or from other information systems, the medical personnel is asked.

Depending on the measurement to be taken, the medical requirements are used for setting the parameters. This setting is based on a medical knowledge base which is accessed by the expert system.

During the examination procedure, the patient may additionally be monitored (e.g. intensive medicine monitoring), critical states are spotted and, if appropriate, result in plan alignment/termination.

1. An apparatus for optimizing the use of different measuring and examination appliances for medical examinations, characterized by an expert system for creating a patient-specific plan for the purposes of selection and parameter configuration on the basis of a suspicious diagnosis or a defined medical problem.

2. The apparatus as claimed in claim 1, characterized in that the expert system simultaneously controls and supervises the implementation of the examination plan, including the administration of medicaments, contrast agents or the like.

3. The apparatus as claimed in claim 1 or 2, characterized in that the expert system is connected to available information systems, such as patient records, appliance databases, medical lexicons or the like.

4. The apparatus as claimed in one of claims 1 to 3, characterized in that the expert system also takes into account, in particular, modality-specific and examination-specific contraindications for plan production.

5. The apparatus as claimed in one of claims 1 to 4, characterized in that it comprises a patient monitoring facility for the purpose of making plan alignments or terminating the examination in line with the state values obtained.

6. The apparatus as claimed in one of claims 1 to 5, characterized in that the expert system generates enquiries to the medical personnel if required in the event of missing or conflicting data which cannot be obtained from suitable sensors, the patient record, the hospital information system or other information systems.

7. The apparatus as claimed in one of claims 1 to 6, characterized in that the expert system is arranged on the premises of a service provider centrally for various users.

8. The apparatus as claimed in one of claims 1 to 6, characterized in that the expert system has a decentralized distributed arrangement on the Internet.

9. The apparatus as claimed in claim 8, characterized by peer to peer concepts for the expert system in order to improve availability and to distribute the requisite computational load.
